(19) United States
(12) Patent Application Publication
(10) Pub. No.: US 2016/0326981 A1
(43) Pub. Date: Nov. 10, 2016

(54) Waste Heat Utilization System

(71) Applicant: DAIMLER AG, Stuttgart (DE)

(72) Inventors: Hartmut KOLB, Ludwigsburg (DE); Hans-Joerg STRUD, Esslingen (DE); Hans-Joachim VON WINTERFELD, Esslingen (DE)

(21) Appl. No.: 15/105,412

(22) PCT Filed: Nov. 26, 2014
(86) PCT No.: PCT/EP2014/003156

§ 371 Date: Jun. 16, 2016

(30) Foreign Application Priority Data
Dec. 19, 2013 (DE) 10 2013 021 578.1

(51) Int. Cl. F02G 5/02; F01D 15/10; F01K 25/08; F01K 13/00; F01K 19/04; H02K 7/18; F01D 17/00

(52) U.S. Cl. CPC F02G 5/02; H02K 7/1823; F01D 15/10; F01D 17/00; F01K 13/00; F01K 19/04; F01K 25/08

(57) ABSTRACT

A waste heat utilization system for an internal combustion engine in a motor vehicle is provided. The system includes a waste heat utilization circuit in which a working medium circulates and has in succession in the flow direction of the working medium a pumping device, at least one vaporizer, an expansion machine for depressurizing, and a condenser. The system also includes a pressure reservoir, which has a cylinder which encloses the balancing volume, and a separating piston, which separates the balancing volume from a gas volume in the cylinder, is arranged in the cylinder. The balancing volume can be actively adjusted by way of an adjusting device and the adjusting device has an adjusting piston which axially constrains the gas volume. The separating piston is arranged in the cylinder, and the adjusting device has an actuator for adjusting the stroke of the adjusting piston.

### BACKGROUND AND SUMMARY OF THE INVENTION

The present invention relates to a waste heat utilization system for an internal combustion engine, in particular in a motor vehicle. The invention also relates to a method for operating a waste heat utilization system of this kind.

A waste heat utilization system, which has a waste heat utilization circuit in which a working medium circulates and which contains in succession in the flow direction of the working medium a pumping device for driving the liquid working medium, a vaporizer for vaporizing the working medium, an expansion machine for depressurizing the gaseous working medium and a condenser for condensing the working medium, is disclosed in DE 10 2009 050 068 A1. A pressure reservoir, which contains a balancing volume filled with liquid working medium and which is fluidically connected to the waste heat utilization circuit between the condenser and the pumping device, is also provided. At the same time, the balancing volume is actively adjustable, that is to say adjustable dependent on the current operating state of the waste heat utilization system, by means of an adjusting device. In the known waste heat utilization system, the adjusting device is designed as a pressure regulating device.

A further waste heat utilization system, which is fitted with an active pressure reservoir which can be actuated with the help of a control device, is disclosed in DE 10 2010 054 733 A1.

A further waste heat utilization system with pressure reservoir is disclosed in DE 10 2011 122 436 A1.

In order to improve a waste heat utilization system with regard to the energy yield, with a hermetically sealed working medium, such as with an organic working medium for example, it is necessary to be able to adapt the pressure in the working medium, for example, by means of an active or controllable pressure reservoir, during the operation of the waste heat utilization system. For example, this enables undesirable reduced pressures within the waste heat utilization circuit to be avoided.

The present invention is concerned with the problem of specifying, for a waste heat utilization system of this kind, an improved or at least an alternative embodiment which is distinguished in particular by an active or controllable pressure reservoir, with the help of which the pressure in the working medium can be varied particularly easily.

The invention is based on the general idea of equipping the pressure reservoir with a cylinder which encloses the balancing volume, wherein an adjusting piston, which can be adjusted in its stroke by an actuator, is arranged in the cylinder. As a result of this measure, the pressure reservoir has a comparatively simple construction. Furthermore, adjustable stroke pistons are technically comparatively easy to manage, as a result of which a reliably operating active or controllable pressure reservoir can be provided.

In a waste heat utilization system of this kind, it can further be provided that the pressure reservoir is either fluidically connected to the waste heat utilization circuit between the condenser and the pumping device, or is arranged in the condenser and therefore fluidically connected to the waste heat utilization circuit within the condenser. The latter leads to an extremely compact arrangement.

A development, in which a separating piston, which separates the balancing volume from a gas volume in the cylinder, is arranged in the cylinder in a stroke-adjustable manner, wherein the adjusting piston axially constrains the gas volume, is particularly advantageous. The separating piston and the adjusting piston therefore lie axially opposite one another in the cylinder, wherein between them they axially constrain the gas volume. With this design, a stroke adjustment of the adjusting piston leads directly to a change in the gas volume. As a result, the pressure in the gas volume is changed accordingly, which then leads to a stroke adjustment of the separating piston. The stroke adjustment of the separating piston then leads to a change in the balancing volume and to a change in the pressure in the working medium. In this way, the pressure in the working medium can be changed indirectly by a stroke adjustment of the adjusting piston. As a result of this design, it is possible to significantly reduce the risk of leakages into the environment, as only the gas volume has to be sealed with respect to the environment.

In an advantageous development, the adjusting piston can contain at least one throttle point, through which gas can transfer from the gas volume into a back volume, which is located on a side of the adjusting piston which faces away from the balancing volume. This enables a vaporization function to be integrated into the adjusting piston in order to be able to damp pressure surges.

A method according to the invention for operating a waste heat utilization system of this kind is characterized in that the balancing volume is adjusted depending on the current operating state of the waste heat utilization system. In particular, the operating method can be designed to the effect that reduced pressures in the waste heat utilization circuit are prevented by adjusting the balancing volume. Furthermore, the operating method can preferably be designed to the effect that the expansion capacity of the expansion machine is optimized in order to maximize the energy yield or waste heat recovery.

According to another advantageous embodiment of the waste heat utilization system, this can be equipped with a control device which is electrically coupled to the adjusting device and which is designed or programmed such that it is capable of executing the above-mentioned operating method.

According to an advantageous embodiment, a vaporizer of the waste heat utilization circuit can be designed as a main vaporizer which is coupled to an exhaust gas system of the internal combustion engine in a heat-transferring manner. For example, this main vaporizer can be arranged in the exhaust gas system downstream of a turbine of an exhaust gas turbocharger and/or downstream of an oxidation catalytic converter.

In addition or alternatively, a vaporizer of the waste heat utilization circuit can be designed as an additional vaporizer which is coupled to an exhaust gas recirculation system of the internal combustion engine in a heat-transferring manner. In the case of an additional vaporizer of this kind, an exhaust gas recirculation cooler within the exhaust gas recirculation system can possibly be dispensed with. An exhaust gas recirculation system of this kind enables exhaust gas to be recirculated from an exhaust gas system of the internal combustion engine to a fresh air system of the internal combustion engine. Expediently, in doing so, this exhaust gas recirculation is arranged on the high-pressure side, that is to say downstream of a compressor of the exhaust gas turbocharger and upstream of the turbine of the exhaust gas turbocharger.

Particularly advantageous is an embodiment of the waste heat utilization system in which a recuperation heat exchanger is provided, which serves to pre-heat the liquid high-pressure working medium, that is to say upstream of the vaporizer, and to pre-cool the gaseous low-pressure working medium, that is to say upstream of the condenser. The energetic efficiency of the waste heat utilization system can be improved with the help of a recuperation heat exchanger of this kind.

Further important characteristics and advantages of the invention can be seen from the drawings and from the associated description of the figures based on the drawings.

It is understood that the characteristics stated above and still to be described below can be used not only in the specified combination in each case, but also in other combinations or in their own right without departing from the scope of the present invention.

Exemplary embodiments of the invention are shown in the drawings and are explained in more detail in the following description, wherein the same references refer to the same or similar or functionally identical components.

### BRIEF DESCRIPTION OF THE DRAWINGS

FIG. 1 is a circuit-diagram-like schematic diagram of an internal combustion engine which is equipped with a waste heat utilization system.

FIG. 2 is a schematic diagram of an active or controllable pressure reservoir.

### DETAILED DESCRIPTION OF THE DRAWINGS

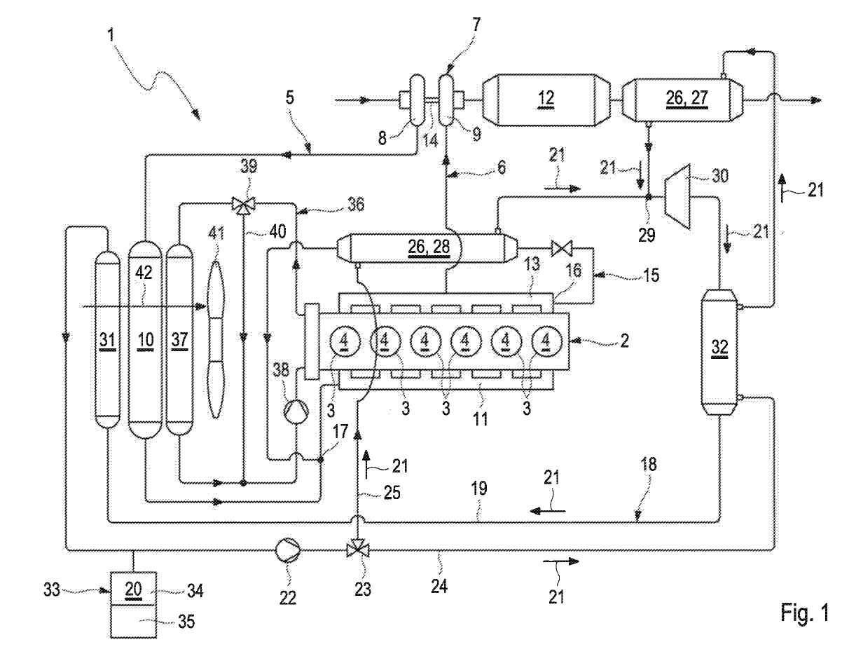

According to FIG. 1, an internal combustion engine 1, which is preferably provided for use in a motor vehicle, in particular in a commercial vehicle, includes an engine block 2 which contains a combustion chamber 4 in each of a plurality of cylinders 3. An in-line six-cylinder engine is shown here by way of example. The internal combustion engine 1 includes a fresh air system 5 for feeding fresh air to the combustion chambers 4 and an exhaust gas system 6 for discharging exhaust gas from the combustion chambers 4. In the example, the internal combustion engine 1 is designed as a charged internal combustion engine 1 so that it is accordingly equipped with an exhaust gas turbocharger 7. In the usual manner, the exhaust gas turbocharger 7 has a compressor 8 which is arranged in the fresh air system 5. Further, the exhaust gas turbocharger 7 is equipped with a turbine 9 which is arranged in the exhaust gas system 6. A charge air cooler 10, which for its part is arranged upstream of a fresh air distributor 11, which distributes the charge air to the individual combustion chambers 4, is arranged in the fresh air system 5 downstream of the compressor 8, that is to say on the high-pressure side. The exhaust gas system 6 contains an oxidation catalytic converter 12 downstream of the turbine 9, and, upstream of the turbine 9, has an exhaust gas accumulator 13, which combines the exhaust gas from the individual combustion chambers 4 and feeds it collectively to the turbine 9. Turbine 9 and compressor 8 are expediently drive-connected by means of a common shaft 14.

The internal combustion engine 1 shown here is also equipped with an exhaust gas recirculation system 15 which feeds back exhaust gas from the exhaust gas system 6 to the fresh air system 5. In doing so, the exhaust gas recirculation system 15 is arranged on the high-pressure side. An extraction point 16 of the exhaust gas recirculation system 15 is therefore connected upstream of the turbine 9 and, in the example of FIG. 1, to the exhaust gas accumulator 13. An intake point 17 of the exhaust gas recirculation system 15 is at the same time connected to the fresh air system 5 downstream of the compressor 8 and, in the example, between the charge air cooler 10 and the fresh air distributor 11.

The internal combustion engine 1 is also equipped with a waste heat utilization system 18. This includes a waste heat utilization circuit 19 in which a working medium 20, preferably an organic working medium 20, circulates. In a flow direction 21, indicated by arrows, of the working medium 20 in the waste heat utilization circuit 19, the waste heat utilization system 18 contains in succession in the waste heat utilization circuit 19 a pumping device 22 for driving the liquid working medium. In the example of FIG. 1, a distributor valve 23, with the help of which the flow of the liquid working medium can effectively be shared between a main branch 24 and a supplementary branch 25, is arranged downstream of the pumping device 22. Both the main branch 24 and the supplementary branch 25 each contain a vaporizer 26. In doing so, the vaporizer 26 of the main branch 24 is designed as a main vaporizer 27, while the vaporizer 26 of the supplementary branch 25 is designed as a supplementary vaporizer 28. The main vaporizer 27 is designed for a greater heat transfer capacity than the supplementary vaporizer 28. The main vaporizer 27 is coupled to the exhaust gas system 6 in a heat-transferring manner. In the example of FIG. 1, the main vaporizer 27 is incorporated into the exhaust gas system 6 downstream of the oxidation catalytic converter 12. On the other hand, the supplementary vaporizer 28 is incorporated into the exhaust gas recirculation system 15. It is worth noting that, in the example, an additional exhaust gas recirculation cooler in the exhaust gas recirculation system 15 can therefore be dispensed with, as the functionality thereof is undertaken by the supplementary vaporizer 28.

Main branch 24 and supplementary branch 25 are brought together at a combining point 29 downstream of the vaporizer 26. This is followed in the flow direction 21 by an expansion machine 30, in which the now gaseous and expediently superheated working medium can be depressurized. In doing so, the expansion machine 30 converts energy of the working medium, in particular enthalpy, into mechanical work, which can then be used further in the form of mechanical work or which can be converted into electrical energy in a generator, for example. A condenser 31, in which the working medium is condensed before it passes to the pumping device 22 once more, is arranged downstream of the expansion machine 30 in the waste heat utilization circuit 19.

In the example of FIG. 1, the waste heat utilization system 18 is also equipped with a recuperation heat exchanger 32, which, on the one hand, is incorporated into the waste heat utilization circuit 19 between the expansion machine 30 and the condenser 31, and, on the other, is incorporated into the main branch 24. In this way, the recuperation heat exchanger 32 is able to couple in a heat-transferring manner the liquid working medium which is to be fed to the main vaporizer 27 with the gaseous working medium coming from the expansion machine 30, as a result of which the working medium fed to the main vaporizer 27 is pre-heated while, at the same time, the working medium coming from the expansion machine 30 is pre-cooled.

Finally, the waste heat utilization system 18 shown here is equipped with a pressure reservoir 33 which contains a balancing volume 34. The balancing volume 34 is filled with liquid working medium 20. In the example of FIG. 1, the pressure reservoir 33 is fluidically connected to the waste heat utilization circuit 19 between the condenser 31 and the pumping device 22. Basically, however, an embodiment in which the pressure reservoir 33 is structurally integrated into the condenser 31 is also conceivable. The pressure reservoir 33 has an adjusting device 35, with the help of which the balancing volume 34 can be adjusted. The pressure reservoir 33 is designed as an active or controllable pressure reservoir 33 so that, with the help of the adjusting device 35, the balancing volume 34 can be actively changed, that is to say during the operation of the internal combustion engine 1 or during the operation of the waste heat utilization system 18. In particular, the balancing volume 34 can be changed depending on the current operating state of the waste heat utilization system 18.

With regard to the embodiment shown in FIG. 1, it must still be mentioned that the internal combustion engine 1 is also equipped with a cooling circuit 36 in which a main cooler 37 and a coolant pump 38 are arranged. Furthermore, a thermostatic valve 39 is provided, with the help of which a bypass 40 for bypassing the main cooler 37 can be controlled. A fan 41 serves to produce or support a cooling air flow 42, in which the condenser 31, the charge air cooler 10 and the main cooler 37 are arranged one after the other, wherein the sequence of the heat exchangers is shown here purely by way of example and depends substantially on the different temperature levels of the media to be cooled.

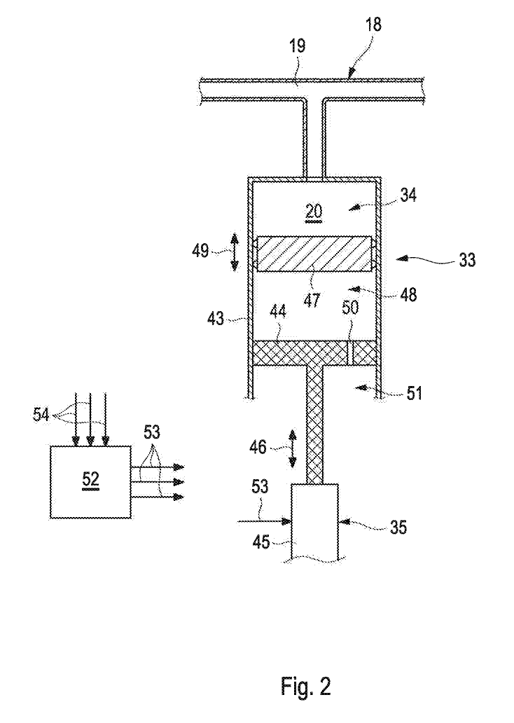

According to FIG. 2, the pressure reservoir 33 has a cylinder 43 which encloses the balancing volume 34. The adjusting device 35, with the help of which the balancing volume 34 can be varied, includes an adjusting piston 44 which is arranged in the cylinder 43 in a stroke-adjustable manner. Further, the adjusting device 35 includes an actuator 45, with the help of which the adjusting piston 44 can be displaced axially relative to the cylinder 43, that is to say in its stroke direction. A corresponding stroke adjustment of the adjusting piston 44 is shown by a double arrow 46 in FIG. 2. A separating piston 47 is also arranged in the cylinder 43 in a stroke-adjusting manner. The separating piston 47 separates a balancing volume 34 from a gas volume 48 in the cylinder 43. In doing so, the separating piston 47 is arranged in the cylinder 43 axially opposing the adjusting piston 44. The separating piston 47 and the adjusting piston 44 thereby constrain the gas volume 48 axially in each case. The adjusting piston 44 can be adjusted in its stroke in the cylinder 43 in accordance with the double arrow 46 with the help of the actuator 45, as a result of which the gas volume 48 can be changed directly. A change in the gas volume 48 leads to a change in the pressure in the gas volume 48. This change in pressure is transmitted via the separating piston 47 to the working medium 20 in the balancing volume 34. As a consequence, this can lead to an adjustment in the stroke of the separating piston 47 in the cylinder 43, which is shown in FIG. 2 by a double arrow 49. A stroke adjustment 49 of the separating piston 47 of this kind is accompanied by a change in the balancing volume 34. The balancing volume 34 can therefore be changed indirectly, namely by means of the gas volume 48, with the help of the actuator 45.

In the example of FIG. 2, the adjusting piston 44 is also equipped with an optionally provided throttle point 50, through which the gas can transfer from the gas volume 48 into a back volume 51 and vice versa. Here, the back volume 51 is located on a side of the adjusting piston 44 facing away from the balancing volume 34. Pressure surges, which can occur in the working medium 20, can be damped with appropriate design of the throttle point 50.

According to FIG. 2, the waste heat utilization system 18 can also be equipped with a control device 52. The control device 52 can have a plurality of outgoing control lines 53, of which at least one is electrically connected to the adjusting device 35 or to the actuator 45. Further, the control device 52 can have a plurality of incoming signal lines 54 which are electrically coupled in a suitable manner to other components of the waste heat utilization system 18, for example to a sensor system and the like. The control device 52 can now be designed or programmed such that it can operate the waste heat utilization system 18 according to a method in which the balancing volume 34 is adjusted depending on the current operating state of the waste heat utilization system 18. For example, the balancing volume 34 is adjusted in such a way that reduced pressures in the working medium 20 are avoided and/or that a maximum energy yield at the expansion machine 30 can be realized.

1.-5. (canceled)

6. A waste heat utilization system for an internal combustion engine in a motor vehicle comprising:
a waste heat utilization circuit in which a working medium circulates and which has in succession in the flow direction of the working medium a pumping device for driving the liquid working medium, at least one vaporizer for vaporizing the working medium, and an expansion machine for depressurizing the gaseous working medium, and a condenser for condensing the working medium, and
a pressure reservoir which contains a balancing volume filled with liquid working medium and which is fluidically connected to the waste heat utilization circuit,
wherein the pressure reservoir has a cylinder which encloses the balancing volume,
wherein a separating piston, which separates the balancing volume from a gas volume in the cylinder, is arranged in the cylinder in a stroke-adjustable manner,
wherein the balancing volume can be actively adjusted by way of an adjusting device,
wherein the adjusting device has an adjusting piston which axially constrains the gas volume,
wherein the separating piston is arranged in the cylinder in a stroke-adjustable manner, and
wherein the adjusting device has an actuator for adjusting the stroke of the adjusting piston.

7. The waste heat utilization system according to claim 6, wherein the adjusting piston contains at least one throttle point, through which gas can transfer from the gas volume into a back volume which is located on a side of the adjusting piston which faces away from the balancing volume.

8. A method for operating the waste heat utilization system according to claim 6, wherein the balancing volume is adjusted depending on the current operating state of the waste heat utilization system.

9. The waste heat utilization system according to claim 8, further comprising a control device, which is electrically coupled to the adjusting device and is configured and/or programmed such that the control device is capable of executing the method according to claim 8.
